(19) United States
(12) Patent Application Publication
(10) Pub. No.: US 2025/0162597 A1
(43) Pub. Date: May 22, 2025

(54) PREDICTIVE OBD ARBITRATION

(71) Applicant: Cummina Inc., Columbus, IN (US)

(72) Inventors: Zachary Schwab, Columbus, IN (US); Ryan Babbitt, Columbus, IN (US); Meenakshi Punetha, Columbus, IN (US); Willis Banks, Scottsburg, IN (US); Neal W. Wallace, Hope, IN (US)

(21) Appl. No.: 18/921,128

(22) Filed: Oct. 21, 2024

Related U.S. Application Data
(60) Provisional application No. 63/599,604, filed on Nov. 16, 2023.

(51) Int. Cl. B60W 50/02; B60W 50/00

(52) U.S. Cl. CPC B60W 50/0205; B60W 50/0097

(57) ABSTRACT

A vehicle system includes an engine configured to selectably operate in a drive state wherein the engine outputs torque to propel the vehicle system and a motoring state wherein the engine is driven by torque from the vehicle system. An electronic control system in operative communication with the engine, is configured to receive a plurality of inputs indicative of vehicle system operating conditions, determine a predicted duration of an engine motoring state in response to the plurality of inputs, receive one or more requests to perform a diagnostic of the engine during engine motoring, select a selected diagnostic corresponding to one of the one or more requests in response to the predicted duration, and perform the selected diagnostic.

### CROSS-REFERENCE

The present application claims priority to and the benefit of U.S. Application No. 63/599,604 filed Nov. 16, 2023, and the same is hereby incorporated by reference.

### BACKGROUND

The present application relates generally to coordination of on board diagnostics (OBD) and more particularly, but not exclusively to predictive OBD arbitration. A number of proposals for coordination of OBD have been proposed. Existing approaches suffer from a number of disadvantages, drawbacks, problems, and shortcomings including those respecting diagnostic coordination, completion, and conflicts, among others. Some coordination techniques may utilize first-come, first-serve scheduling of multiple diagnostics. Some diagnostics may require intrusive perturbation of an engine during certain conditions to detect certain failure conditions and may require such perturbation during certain operating conditions, and for certain amounts of time. The foregoing and other aspects of conventional approaches create competition, conflicts, and incompletion in conventional approaches such as first-come, first-serve approaches. There remains a significant need for the unique apparatuses, processes, and systems of the following disclosure.

### DISCLOSURE OF EXAMPLE EMBODIMENTS

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention as set forth in the claims following this disclosure includes and protects such alterations, modifications, and further applications of the example embodiments as would occur to one skilled in the art with the benefit of the present disclosure.

### SUMMARY OF THE DISCLOSURE

Some embodiments include unique power converter apparatus. Some embodiments include unique power converter systems. Some embodiments include unique power converter processes. Further embodiments, forms, objects, features, advantages, aspects, and benefits shall become apparent from the following description and drawings.

### BRIEF DESCRIPTION OF THE DRAWINGS

FIG. 1 is a schematic diagram illustrating certain aspects of an example system including a power converter apparatus.

FIG. 2 is a schematic diagram illustrating certain aspects of example controls.

FIG. 3 is a schematic diagram illustrating certain aspects of example controls.

FIGS. 4-6 are graphs illustrating certain aspects of several example operational scenarios.

### DETAILED DESCRIPTION OF EXAMPLE EMBODIMENTS

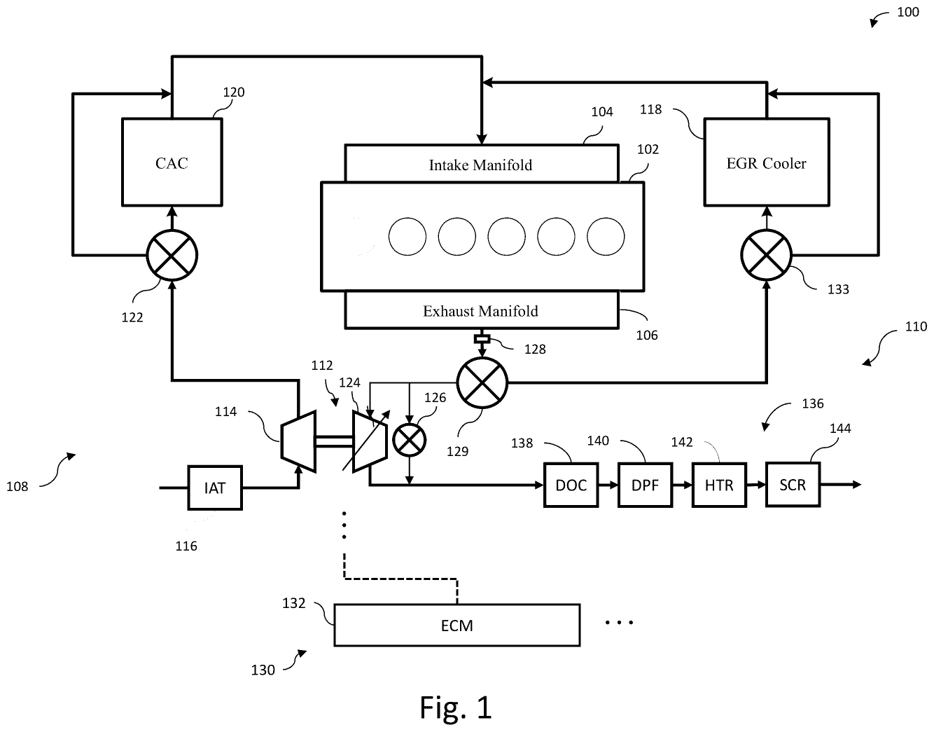

With reference to FIG. 1, there is illustrated an example prime mover system 100 (also referred to herein as system 100) including a prime mover in the form of an internal combustion engine (ICE) 102. System 100 may be provide in a number of forms including, for example, in the form of a vehicle or vehicle powertrain system (e.g., an on-highway vehicle or vehicle powertrain system or an off-highway vehicle or vehicle powertrain system), a work machine or work machine powertrain system, a genset or genset powertrain system, or a hydraulic fracturing rig or hydraulic fracturing rig powertrain system, to name several non-limiting examples. In shall be appreciated that system 100 may include a number of other components as will occur to one of skill in the art with the benefit and insight of the present disclosure. Furthermore, while engine 102 is provided as a prime mover of system 100 in the illustrated embodiment, other embodiments may comprise other types of prime movers, for example, battery electric drive systems, hybrid ICE-battery electric systems, a fuel cell electric drive system, or prime mover systems comprising combinations of the foregoing and/or other types of prime mover system as will occur to one of skill in the art with the benefit and insight of the present disclosure.

System 100 includes an intake system 108 and an exhaust system 110. The engine 102 is in fluid communication with the intake system 108 through which charge air enters an intake manifold 104 and is also in fluid communication with the exhaust system 110, through which exhaust gas resulting from combustion exits by way of an exhaust manifold 106. The engine 102 includes a number of cylinders (e.g., cylinders 1 through 6) forming combustion chambers in which a charge flow mixture of fuel and air is combusted. For example, the energy released by combustion powers the engine 102 via pistons in the cylinders connected to a crankshaft. Intake valves control the admission of charge air into the cylinders, and exhaust valves control the outflow of exhaust gas through exhaust manifold 106 and ultimately to the atmosphere. It shall be appreciated that the exhaust manifold 106 may be a single manifold or multiple exhaust manifolds.

The turbocharger 112 includes a compressor 114 configured to receive filtered intake air via an intake air throttle (IAT) 116 of the intake system 108 and operable to compress ambient air before the ambient air enters the intake manifold 104 of the engine 102 at increased pressure. The air from the compressor 114 is pumped through the intake system 108, to the intake manifold 104, and into the cylinders of the engine 102, typically producing torque on the crankshaft. IAT 116 is flow coupled with a charge air cooler (CAC) 120 which is operable to cool the charge flow provided to the intake manifold 104. The intake system 108 also includes a CAC bypass valve 122 which can be opened to route a portion or all of the charge flow to bypass the CAC 120. Adjusting the bypass position of the CAC bypass valve 122 increasingly raises the temperature of the gas returned to the intake manifold 104.

It is contemplated that in system 100, the turbocharger 112 may be a variable geometry turbocharger (VGT) or a fixed geometry turbocharger. A variable geometry turbine allows significant flexibility over the pressure ratio across the turbine. In diesel engines, for example, this flexibility can be used for improving low speed torque characteristics, reducing turbocharger lag and driving exhaust gas recirculation flow. In an example embodiment, the VGT 124 can be adjusted to increase engine load and thereby configured to increase exhaust gas temperature. System 100 also includes a turbine bypass valve 126 to bypass the turbocharger 112. Since cooler ambient air is introduced at the turbocharger 112, opening the turbine bypass valve 126 allows for the turbocharger 112 to be bypassed and maintain a higher intake air temperature at the intake manifold 104.

The exhaust system 110 includes an exhaust gas temperature sensor 128 to sense the temperature of the gas exiting the exhaust manifold 106. The exhaust system 110 includes an exhaust gas recirculation (EGR) valve 129 which recirculates a portion of exhaust gas from the exhaust manifold 106 back to the intake manifold 104. The exhaust system 110 includes an EGR cooler (EGR-C) 118 which cools the gas exiting the exhaust manifold 106 before the gas returns to the intake manifold 104. The exhaust system 110 may also include an EGR-C bypass valve 133 which can be opened to route a portion or all of the recirculated exhaust gas from the exhaust manifold 106 to bypass the EGR-C 118. By increasing the amount of gas that bypasses the EGR-C 118, the temperature of the gas returning to the intake manifold 104 is increased. It shall be appreciated that the intake system 108 and/or the exhaust system 110 may further include various components not shown, such as additional coolers, valves, bypasses, intake throttle valves, exhaust throttle valves, and/or compressor bypass valves, for example.

System 100 includes an exhaust aftertreatment (AT) system 136 which includes a diesel oxidation catalyst (DOC) 138, a diesel particulate filter (DPF) 140, aftertreatment (AT) heater 142, and a selective catalytic reduction (SCR) 144. In the example embodiment, the AT heater 142 is optionally included in the AT system 136 to increase the temperature of the exhaust gas provided to the SCR 144 within the AT system 136. It should be noted that AT heater 142 can include one or more electric heaters distributed at various locations at, on, within, or upstream of SCR 144 or other catalyst elements of AT system 136.

System 100 includes an electronic control system (ECS) 130. In the illustrated embodiment, ECS 130 include an engine control unit (ECU) 132 which is operatively communicatively coupled with and configured and operable to control operation of and/or receive inputs from actuators, controllers, devices, sensors, and/or other components of system 100 including, for example, a number of the aforementioned features of system 100. System 100 may include a number of other control units and controller as will occur to one of skill in the art with the benefit and insight of the present disclosure. It shall be appreciated that various communications hardware and protocols may be utilized to implement, such as one or more controller area networks (CAN) or other communications components.

ECU 132 and other components of ECS 130 may include one or more programmable controllers of a solid-state, integrated circuit type, and one or more non-transitory memory media configured to store instructions executable by the one or more microcontrollers. For purposes of the present application the term controller shall be understood to also encompass microcontrollers, microprocessors, application specific integrated circuits (ASIC), other types of integrated circuit processors and combinations thereof.

ECU 132 and other components of ECS 130 may be implemented in any of a number of ways that combine or distribute the control function across one or more control units in various manners. The ECS 130 may execute operating logic that defines various control, management, and/or regulation functions. This operating logic may be in the form of dedicated hardware, such as a hardwired state machine, analog calculating machine, programming instructions, and/or a different form as would occur to those skilled in the art. The ECS 130 may be provided as a single component or a collection of operatively coupled components; and may be comprised of digital circuitry, analog circuitry, or a hybrid combination of both of these types. When of a multi-component form, the ECS 130 may have one or more components remotely located relative to the others in a distributed arrangement. The ECS 130 can include multiple processing units arranged to operate independently, in a pipeline processing arrangement, in a parallel processing arrangement, or the like. It shall be further appreciated that the ECS 130 and/or any of its constituent components may include one or more signal conditioners, modulators, demodulators, Arithmetic Logic Units (ALUs), Central Processing Units (CPUs), limiters, oscillators, control clocks, amplifiers, signal conditioners, filters, format converters, communication ports, clamps, delay devices, memory devices, Analog to Digital (A/D) converters, Digital to Analog (D/A) converters, and/or different circuitry or components as would occur to those skilled in the art to perform the desired communications.

ECU 132 and other components of ECS 130 may include one or more non-transitory memory devices configured to store instructions in memory which are readable and executable by a controller to control operation of engine 102 as described herein. Certain control operations described herein include operations to determine one or more parameters. ECU 132 and other components of ECS 130 may be configured to determine and may perform acts of determining in a number of manners, for example, by calculating or computing a value, obtaining a value from a lookup table or using a lookup operation, receiving values from a datalink or network communication, receiving an electronic signal (e.g., a voltage, frequency, current, or pulse-width modulation (PWM) signal) indicative of the value, receiving a parameter indicative of the value, reading the value from a memory location on a computer-readable medium, receiving the value as a run-time parameter, and/or by receiving a value by which the interpreted parameter can be calculated, and/or by referencing a default value that is interpreted to be the parameter value.

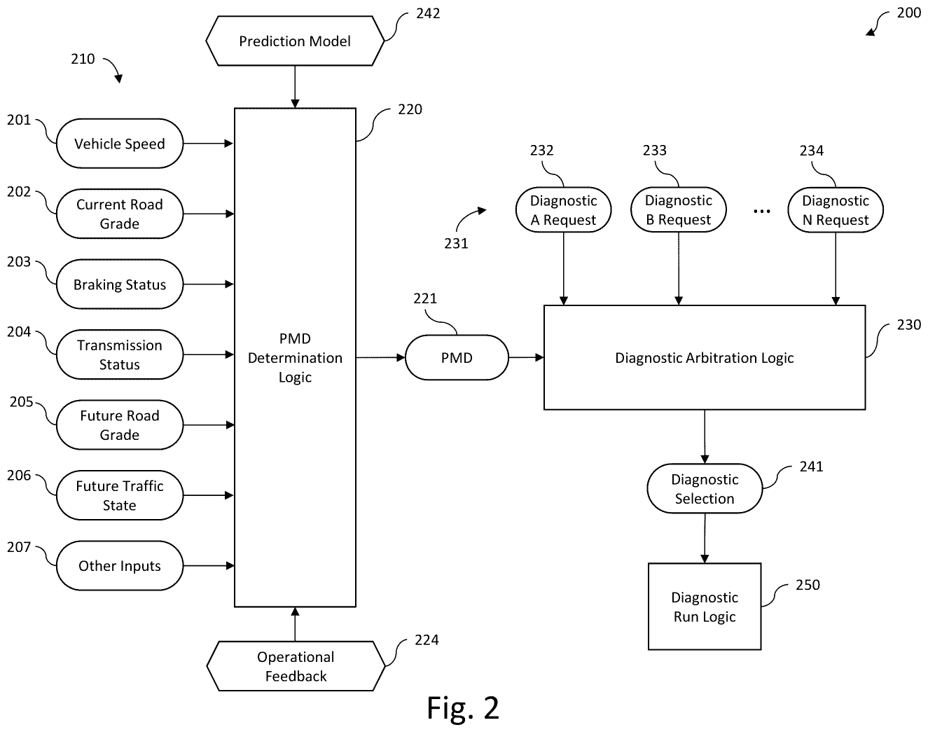

With reference to FIG. 2, there are illustrated example controls 200 which may be implemented and operated in connection with an electronic control system such as ECS 130 or another electronic control system. Controls 200 include predicted motoring duration logic 220 which is configured to receive a prediction model 242, for example, during calibration or tuning of controls 200, and to utilize the prediction model 242 to determine and output a predicted motoring duration (PMD) 221 in response to a plurality of inputs 210.

It shall be appreciated that a motoring state comprises a state wherein an engine is turned without combustion, such as when an engine is driven by torque from the vehicle system, for example, when a vehicle is coasting with a driveline engaged or when an engine is driven by an electric motor of a vehicle system. It shall also be appreciated that diagnostics according to the present disclosure may comprise motoring diagnostics which are required to run during a motoring state of an engine, and may comprise intrusive motoring diagnostics which are required to perturbate or otherwise disrupt engine operation during a motoring state of an engine. Some example motoring diagnostics include fueling quantity and timing diagnostics, NOx sensor rationality diagnostics, and reductant delivery diagnostic, among others.

In the illustrated embodiment, the prediction model 242 comprises a multivariate linear regression model which is empirically determined to provide predicted durations of future motoring events in response to varying values of the plurality of inputs 210. In other embodiments, other types of models may be utilized to provide predicted durations of future motoring events in response to varying values of the plurality of inputs 210. The predicted durations of future motoring events may be provided and output from predicted motoring duration logic as PMD 221. In some embodiments, the prediction model 242 may be configured to operate and to determine and output PMD 221 in response to an engine system entering a motoring state. In some embodiments, the prediction model 242 may be configured to operate and to determine and output PMD 221 predictively, prior to an engine system entering a motoring state or based a prediction or indication that an engine will or is likely to enter a motoring state.

In the illustrated embodiment, the plurality of inputs 210 comprise a vehicle speed 201, a current road grade 202, a braking status 203, a transmission status 204, a future road grade 205, a future traffic state 206, and potentially other inputs 207. The vehicle speed 201 may be received from a physical, virtual or hybrid physical-virtual vehicle speed sensor. The current road grade 202 may be received from a physical, virtual or hybrid physical-virtual road grade sensor. The braking status 203 may be received from a vehicle braking system. The transmission status 204 which may be received from a transmission system. The future road grade 205 may be received from a look-ahead system which may utilize a predicted future vehicle location and a map stored in a non-transitory computer-readable memory medium indicating road grades at a plurality of potential vehicle locations and which may utilize a GPS location and/or inputs from a telematics system in predicting future vehicle location. The future traffic state 206 may be received from telematics system. It shall be appreciated that in other embodiments, the plurality of inputs 210 may comprise may utilized additional and/or alternative inputs which may be correlated with or otherwise utilized in predicting a durations of a future motoring event.

It shall be appreciated that the aforementioned operation of controls 200 to determine a predicted motoring duration using prediction model 242 may be considered an open-loop determination. Predicted motoring duration logic 220 may also receive operational feedback 224 which may be utilized in adjusting or modifying determinations of predicted durations of future motoring events in response to feedback indicative of operation of an engine. In some embodiments, the operational feedback 224 may comprise one or more actual motoring times which may be compared to predicted motoring time. A difference between an actual motoring time and a predicted motoring time may be utilized to adjust or modify a determination of a predicted duration of a future motoring event. In some embodiments, a trend of the estimate being longer or shorter than the actual motoring time may be utilized to adjust or modify such a determination. In some embodiments, an average error estimate for the last number N of motoring events may be added to an open-loop model based determination such as the aforementioned determination. In some embodiments, the number N may be 10 or another suitable number.

Controls 200 include a diagnostic arbitration logic 230 which receives as input PMD 221 and one or more diagnostic requests 231. In the illustrated embodiment and operational state, the one or more diagnostic requests 231 comprise a plurality of diagnostic requests including diagnostic request 232 for a first diagnostic, diagnostic request 233 for a second diagnostic, and a diagnostic request 234 for a third diagnostic. It shall be appreciated that other embodiment and other operational states may receive a different number (greater or fewer) diagnostics requests and/or at a given point in time may receive only some of the total number of potential diagnostic requests that can potentially be received. Diagnostic arbitration logic 230 is configured to select a diagnostic selection 241 corresponding to one of the one or more diagnostic requests 231 in response to PMD 221. Diagnostic selection 241 may be provided to diagnostic run logic 250 which may perform a diagnostic corresponding to the diagnostic selection 241

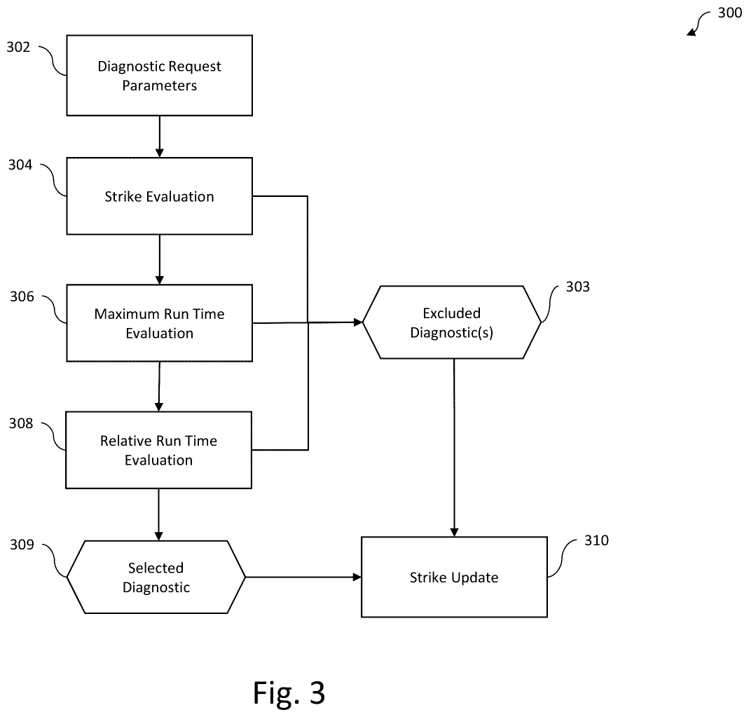

Referring now to FIG. 3, there are illustrated example controls 300 which may be implemented and operated in connection with an electronic control system such as ECS 130 or another electronic control system. Controls 300 may, for example, be utilized by or in connection with diagnostic arbitration logic 230 to select diagnostic selection 241 in response to PMD 221.

Controls 300 are configured to provide diagnostic request parameters 302 to strike evaluation logic 304. Diagnostic request parameters 302 may include strike parameters and run time parameters corresponding to particular diagnostic requests and their associated diagnostic. Thus, for, example, diagnostic parameters may comprise a first strike parameter and a first run time parameter corresponding to a first diagnostic requests and an associated first diagnostic, a second strike parameter and a second run time parameter corresponding to a second diagnostic requests and an associated second diagnostic, and one or more other strike parameters and a other run time parameters corresponding to a number of other diagnostic requests and associated diagnostics.

Strike evaluation logic 304 may evaluate whether a strike condition is established such that a given diagnostic request and associated diagnostic should be inhibited or prevented from execution. Strike parameters may be assigned to a given diagnostic request and/or a given diagnostic based on a number of times that a given diagnostic has been performed, a recency with which a given diagnostic has been performed, a number of instances where a given diagnostic prevented another diagnostic from running, or a combination of the foregoing and/or other criteria. Strike evaluation logic 304 may designate or assign one or more diagnostic requests and associated diagnostics as excluded diagnostics 303. Any diagnostic requests and associated diagnostics that are not so assigned are passed to maximum run time evaluation logic 306.

Maximum run time evaluation logic 306 compares a run time parameter of each diagnostic request and associated diagnostic that it receives as input with a maximum time limit which may be established in response to PMD 221. In some embodiments and instances the PMD 221 may be utilized directly as a maximum time limit. In some embodiments and instances the PMD 221 may be utilized indirectly to establish a maximum time limit, for example, by applying an offset or margin of error to PMD 221. Maximum run time evaluation logic 306 may designate or assign one or more diagnostic requests and associated diagnostics as excluded diagnostics 303. Any diagnostic requests and associated diagnostics that are not so assigned are passed to relative run time evaluation logic 308.

Relative run time evaluation logic 308 selects the one or one or more diagnostics that are passed to it comprising the longest run time duration as a selected diagnostic 309. In other words, if multiple diagnostic requests are passed to relative run time evaluation logic 308, the diagnostic with the longest run time parameter less than a predicted motoring time may be selected as a selected diagnostic 309 and may, thereafter, be performed. Selected diagnostic 309 may be output as diagnostic selection 241.

Excluded diagnostic(s) 303 and selected diagnostic 309 are passed to strike update logic 310 which may adjust the strikes against each diagnostic. For example, strike update logic 310 may add a strike to selected diagnostic 309 and remove a strike from each of the excluded diagnostics 303. In some embodiments and implementations, a single strike architecture may be utilized wherein only a single diagnostic is assigned a strike at any time. In some embodiments and implementations, a multi-strike architecture may be utilized wherein each diagnostic may be assigned a number of strikes that are incremented and decrements dynamically. Thus, depending on the architecture utilized, strike evaluation logic 304 may then pass only diagnostics having no strikes, a lowest number of strikes, or a number of strikes below a predetermined threshold to maximum run time evaluation logic 306.

Controls 200 and controls 300 may be operated both before and during motoring events. Such operation may be effective to maximize or optimize the number of diagnostics that can be performed during a motoring event. The dynamic operation of controls 200 before and during motoring events shall now be described through several example operational scenarios.

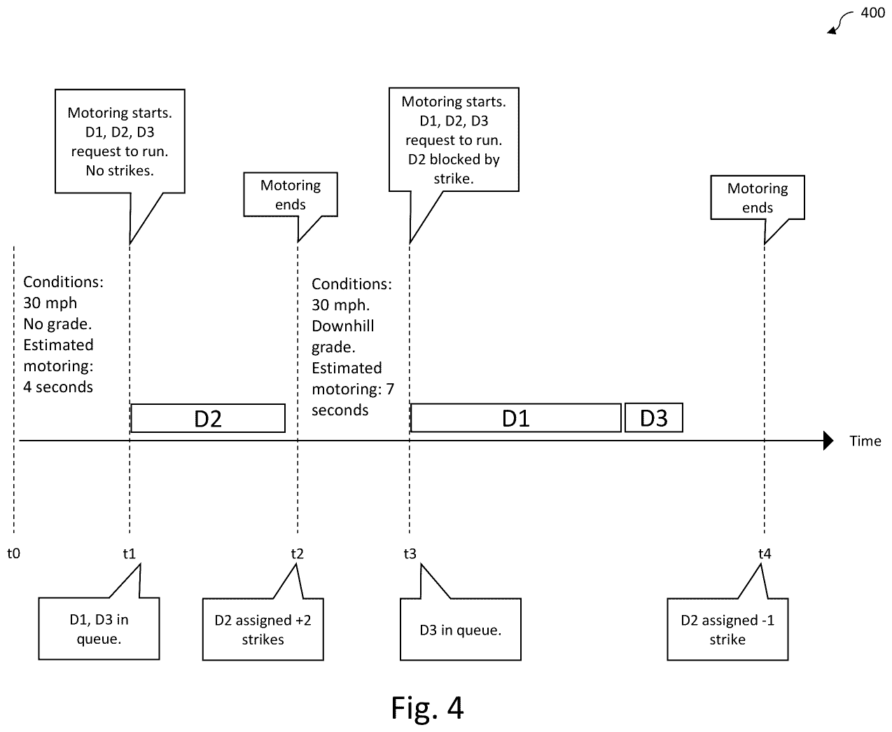

With reference to FIG. 4, there is illustrated a graph 400 depicting certain aspects of an example operational scenario. At time t1, a motoring event begins. Additionally, at time t1 or shortly thereafter, controls 200 estimate a motoring duration of 4 seconds in response to conditions including a vehicle speed of 30 mph and no grade (or in some embodiments may have previously estimated the motoring duration). Diagnostics D1, D2, and D3 have requested to run and none of the diagnostics has any strikes. Diagnostic D2 is selected and performed as it has the longest run time that will fit within the estimated motoring duration. Diagnostics D1 and D3 remain in a request queue. At time t2, the motoring event ends and a two strikes are added to a strike count of diagnostic D2 which has superseded or preempted running of diagnostics D1 and D3.

After time t3, controls 200 have estimated a motoring duration of 7 seconds in response to conditions including a vehicle speed of 30 mph and a downhill grade. At time t3, a motoring event begins. Diagnostics D1, D2, and D3 have requested to run and Diagnostic D2 has a strike.

Diagnostic D1 is selected and performed as it has the longest run time that will fit within the estimated motoring duration. Diagnostics D3 remain in the request queue. Once diagnostic D3 has completed, diagnostic D3 is selected and performed as it now has the longest run time that will fit within the remaining duration of the estimated motoring duration. At time t4, the motoring event ends and a strike is removed from the strike count of diagnostic D2 which has not superseded other diagnostics. In the illustrated example no strike is added to diagnostic D1 or diagnostic D3, as diagnostic D2 was ineligible to run based on its strike count and therefore is not considered to be superseded or preempted by running of diagnostics D1 and D3. In other embodiments, different strike count increment/decrement logic may be utilized and one or both of diagnostics D1 and D3 may be assigned a strike to elevate priority of future execution of diagnostic D2.

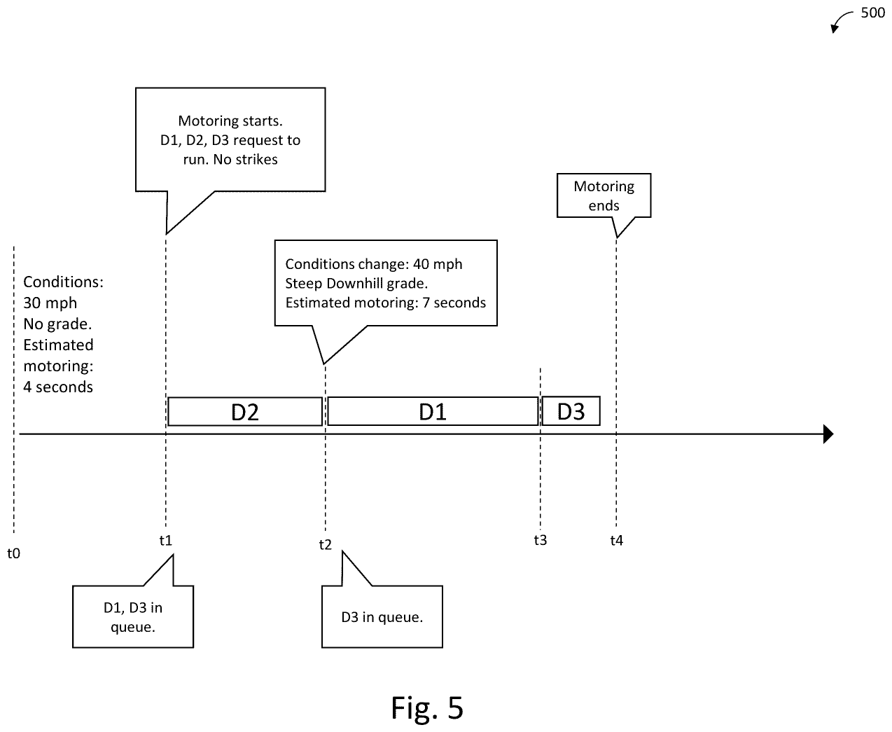

With reference to FIG. 5, there is illustrated a graph 500 depicting certain aspects of another example operational scenario. At time t1, a motoring event begins. Additionally, at time t1 or shortly thereafter, controls 200 estimate a motoring duration of 4 seconds in response to conditions including a vehicle speed of 30 mph and no grade (or in some embodiments may have previously estimated the motoring duration). Diagnostics D1, D2, and D3 have requested to run and none of the diagnostics has any strikes. Diagnostic D2 is selected and performed as it has the longest run time that will fit within the estimated motoring duration (initially the duration between time t1 and time t2). Diagnostics D1 and D3 remain in a request queue.

At time t2, controls 200 have estimated an updated motoring duration of 7 seconds in response to changed conditions including a vehicle speed of 40 mph and a steep downhill grade. Diagnostic D1 is selected and performed as it has the longest run time that will fit within the estimated remaining motoring duration (the duration between time t2 and time t3). Diagnostics D3 remain in a request queue.

At time t3 the updated estimated motoring duration of 7 seconds remains unchanged and diagnostic D1 is selected and performed as it has the longest run time that will fit within the estimated remaining motoring duration (the duration between time t3 and time t4). At time t4, the motoring event ends. None of diagnostics D1, D2, and D3 is assigned a strike as none has superseded or preempted by running of another.

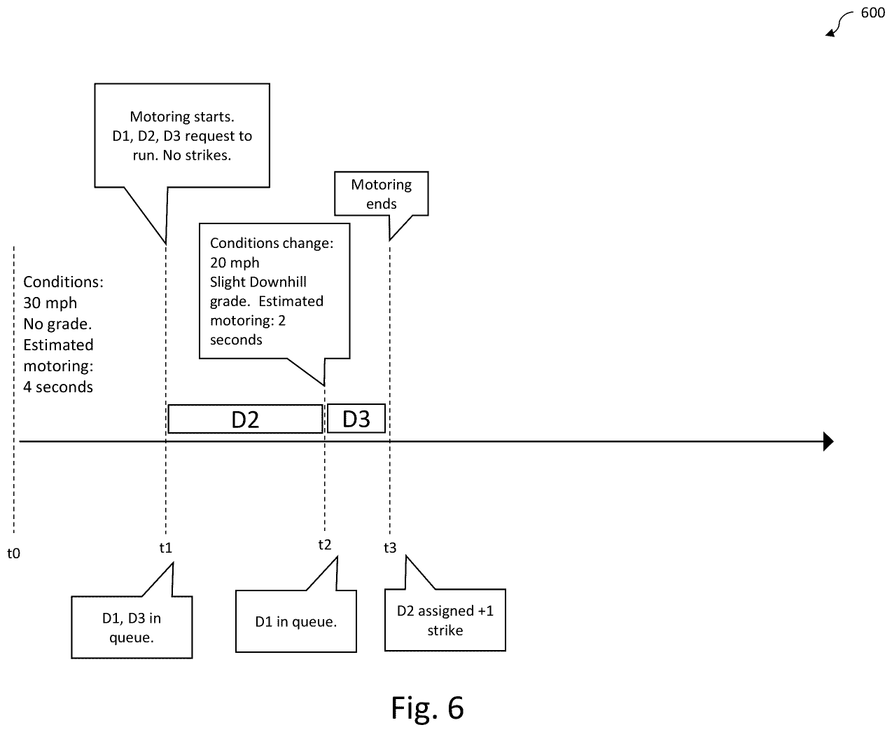

With reference to FIG. 6, there is illustrated a graph 600 depicting certain aspects of another example operational scenario. At time t1, a motoring event begins. Additionally, at time t1 or shortly thereafter, controls 200 estimate a motoring duration of 4 seconds in response to conditions including a vehicle speed of 30 mph and no grade (or in some embodiments may have previously estimated the motoring duration). At time t1, a motoring event begins. Diagnostics D1, D2, and D3 have requested to run and none of the diagnostics has any strikes. Diagnostic D2 is selected and performed as it has the longest run time that will fit within the estimated motoring duration (initially the duration between time t1 and time t2). Diagnostics D1 and D3 remain in a request queue.

At time t2, controls 200 have estimated an updated motoring duration of 2 seconds in response to changed conditions including a vehicle speed of 20 mph and a slight downhill grade. Diagnostic D3 is selected and performed as it has the longest run time that will fit within the estimated remaining motoring duration (the duration between time t2 and time t3). Diagnostics D3 remain in a request queue.

At time t3, the motoring event ends and a strike is added to a strike count of diagnostic D2 which has superseded or preempted running of diagnostics D1 which could have been run in the originally estimated motoring duration, but was not. In the illustrated embodiment, a strike is not assigned to diagnostic D3 as it ran within a time that diagnostic D1 could not have been completed and therefore may be considered not to have superseded or preempted running of diagnostic D1. In other embodiments, different strike count increment/decrement logic may be utilized and diagnostics D1 may also be assigned a strike to elevate priority of future execution of diagnostic D2 based on execution rather than conditional preemption.

As shown by this detailed description, the present disclosure contemplates multiple and various embodiments, including, without limitation, the following example embodiments.

A first example embodiment is a vehicle system comprising: an engine configured to selectably operate in a drive state wherein the engine outputs torque to propel the vehicle system and a motoring state wherein the engine is driven by torque from the vehicle system; and an electronic control system in operative communication with the engine, the electronic control system being configured to perform the acts of: receiving a plurality of inputs indicative of vehicle system operating conditions, receiving one or more requests to perform a diagnostic of the engine with the engine in a motoring state, selecting a selected diagnostic corresponding to one of the one or more requests, the selected diagnostic varying in response to a duration of the engine motoring state, and performing the selected diagnostic.

A second example embodiment includes the features of the first example embodiment, wherein the plurality of inputs comprise a vehicle speed, a brake status, and a current road grade.

A third example embodiment includes the features of the first example embodiment or the second example embodiment, wherein the plurality of inputs comprise one or more look-ahead inputs.

A fourth example embodiment includes the features of the third example embodiment, wherein the one or more look-ahead inputs comprise one or more of a look-ahead road grade, and look-ahead traffic information.

A fifth example embodiment includes the features of the first example embodiment, wherein the electronic control system is configured to perform the acts of: evaluating a respective strike parameter for the one or more requests, and in response to the evaluating, excluding from the selecting at least one of the one or more requests.

A sixth example embodiment includes the features of the first example embodiment, comprising determining a predicted duration of an engine motoring state in response to the plurality of inputs, wherein the act of selecting the selected diagnostic is responsive to the predicted duration.

A seventh example embodiment includes the features of the sixth example embodiment, wherein the selected diagnostic comprises a diagnostic comprising a greatest run time that does not exceed the predicted duration of the engine motoring state.

An eighth example embodiment includes the features of the sixth example embodiment, wherein the determining the predicted duration of an engine motoring state utilizes an empirically determined model.

A ninth example embodiment includes the features of the sixth example embodiment, wherein the electronic control system is configured to perform an act of adjusting the determining the predicted duration of the engine motoring state in response to operation of the engine.

A tenth example embodiment includes the features of the ninth example embodiment, wherein the act of adjusting the determining comprises comparing a predicted motoring time and an observed motoring time, and adjust the subsequent acts of the determining based on a difference between the predicted motoring time and the observed motoring time

An eleventh example embodiment is a process for operating a vehicle system including an engine configured to selectably operate in a drive state wherein the engine outputs torque to propel the vehicle system and a motoring state wherein the engine is driven by torque from the vehicle system, the process comprising: receiving a plurality of inputs indicative of vehicle system operating conditions; receiving one or more requests to perform a diagnostic of the engine with the engine in a motoring state, selecting a selected diagnostic corresponding to one of the one or more requests, the selected diagnostic varying in response to a duration of the engine motoring state, and performing the selected diagnostic.

A twelfth example embodiment includes the features of the eleventh example embodiment, wherein the plurality of inputs comprise a vehicle speed, a brake status, and a current road grade.

A thirteenth example embodiment includes the features of the eleventh example embodiment or the twelfth example embodiment, wherein the plurality of inputs comprise one or more look-ahead inputs.

A fourteenth example embodiment includes the features of the thirteenth example embodiment, wherein the one or more look-ahead inputs comprise one or more of a look-ahead road grade, and look-ahead traffic information.

A fifteenth example embodiment includes the features of the eleventh example embodiment, wherein the electronic control system is configured to perform the acts of: evaluating a respective strike parameter for the one or more requests, and in response to the evaluating, excluding from the selecting at least one of the one or more requests.

A sixteenth example embodiment includes the features of the eleventh example embodiment, comprising determining a predicted duration of an engine motoring state in response to the plurality of inputs, wherein the act of selecting the selected diagnostic is responsive to the predicted duration.

A seventeenth example embodiment includes the features of the sixteenth example embodiment, wherein the selected diagnostic comprises a diagnostic comprising a greatest run time that does not exceed the predicted duration of the engine motoring state.

An eighteenth example embodiment includes the features of the sixteenth example embodiment, wherein the determining the predicted duration of an engine motoring state utilizes an empirically determined model.

A nineteenth example embodiment includes the features of the sixteenth example embodiment, wherein the electronic control system is configured to perform an act of adjusting the determining the predicted duration of the engine motoring state in response to operation of the engine.

A twentieth example embodiment includes the features of the nineteenth example embodiment, wherein the adjusting the determining comprises comparing a predicted motoring time and an observed motoring time, and adjust the subsequent acts of the determining based on a difference between the predicted motoring time and the observed motoring time

It shall be appreciated that terms such as “a non-transitory memory,” “a non-transitory memory medium,” and “a non-transitory memory device” refer to a number of types of devices and storage mediums which may be configured to store information, such as data or instructions, readable or executable by a processor or other components of a computer system and that such terms include and encompass a single or unitary device or medium storing such information, multiple devices or media across or among which respective portions of such information are stored, and multiple devices or media across or among which multiple copies of such information are stored.

It shall be appreciated that terms such as “determine,” “determined,” “determining” and the like when utilized in connection with a control method or process, an electronic control system or controller, electronic controls, or components or operations of the foregoing refer inclusively to a number of acts, configurations, devices, operations, and techniques including, without limitation, calculation or computation of a parameter or value, obtaining a parameter or value from a lookup table or using a lookup operation, receiving parameters or values from a datalink or network communication, receiving an electronic signal (e.g., a voltage, frequency, current, or pulse-width modulation (PWM) signal) indicative of the parameter or value, receiving output of a sensor indicative of the parameter or value, receiving other outputs or inputs indicative of the parameter or value, reading the parameter or value from a memory location on a computer-readable medium, receiving the parameter or value as a run-time parameter, and/or by receiving a parameter or value by which the interpreted parameter can be calculated, and/or by referencing a default value that is interpreted to be the parameter value.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A vehicle system comprising:
an engine configured to selectably operate in a drive state wherein the engine outputs torque to propel the vehicle system and a motoring state wherein the engine is driven by torque from the vehicle system; and
an electronic control system in operative communication with the engine, the electronic control system being configured to perform the acts of:
receiving a plurality of inputs indicative of vehicle system operating conditions,
receiving one or more requests to perform a diagnostic of the engine with the engine in a motoring state,
selecting a selected diagnostic corresponding to one of the one or more requests, the selected diagnostic varying in response to a duration of the engine motoring state, and
performing the selected diagnostic.

2. The vehicle system of claim 1, wherein the plurality of inputs comprise a vehicle speed, a brake status, and a current road grade.

3. The vehicle system of claim 1, wherein the plurality of inputs comprise one or more look-ahead inputs.

4. The vehicle system of claim 3, wherein the one or more look-ahead inputs comprise one or more of a look-ahead road grade, and look-ahead traffic information.

5. The system of claim 1, wherein the electronic control system is configured to perform the acts of:
evaluating a respective strike parameter for the one or more requests, and
in response to the evaluating, excluding from the selecting at least one of the one or more requests.

6. The system of claim 1, comprising determining a predicted duration of an engine motoring state in response to the plurality of inputs, wherein the act of selecting the selected diagnostic is responsive to the predicted duration.

7. The system of claim 6, wherein the selected diagnostic comprises a diagnostic comprising a greatest run time that does not exceed the predicted duration of the engine motoring state.

8. The system of claim 6, wherein the determining the predicted duration of an engine motoring state utilizes an empirically determined model.

9. The system of claim 6, wherein the electronic control system is configured to perform an act of adjusting the determining the predicted duration of the engine motoring state in response to operation of the engine.

10. The system of claim 9, wherein the act of adjusting the determining comprises comparing a predicted motoring time and an observed motoring time, and adjust the subsequent acts of the determining based on a difference between the predicted motoring time and the observed motoring time.

11. A process for operating a vehicle system including an engine configured to selectably operate in a drive state wherein the engine outputs torque to propel the vehicle system and a motoring state wherein the engine is driven by torque from the vehicle system, the process comprising:
receiving a plurality of inputs indicative of vehicle system operating conditions;
receiving one or more requests to perform a diagnostic of the engine with the engine in a motoring state,
selecting a selected diagnostic corresponding to one of the one or more requests, the selected diagnostic varying in response to a duration of the engine motoring state, and
performing the selected diagnostic.

12. The process of claim 11, wherein the plurality of inputs comprise a vehicle speed, a brake status, and a current road grade.

13. The process of claim 11, wherein the plurality of inputs comprise one or more look-ahead inputs.

14. The process of claim 13, wherein the one or more look-ahead inputs comprise one or more of a look-ahead road grade, and look-ahead traffic information.

15. The process of claim 11, wherein the electronic control system is configured to perform the acts of:
evaluating a respective strike parameter for the one or more requests, and
in response to the evaluating, excluding from the selecting at least one of the one or more requests.

16. The process of claim 11, comprising determining a predicted duration of an engine motoring state in response to the plurality of inputs, wherein the act of selecting the selected diagnostic is responsive to the predicted duration.

17. The process of claim 16, wherein the selected diagnostic comprises a diagnostic comprising a greatest run time that does not exceed the predicted duration of the engine motoring state.

18. The process of claim 16, wherein the determining the predicted duration of an engine motoring state utilizes an empirically determined model.

19. The process of claim 16, wherein the electronic control system is configured to perform an act of adjusting the determining the predicted duration of the engine motoring state in response to operation of the engine.

20. The process of claim 19, wherein the adjusting the determining comprises comparing a predicted motoring time and an observed motoring time, and adjust the subsequent acts of the determining based on a difference between the predicted motoring time and the observed motoring time.
